(19) United States
(12) Patent Application Publication
(10) Pub. No.: US 2024/0170217 A1
(43) Pub. Date: May 23, 2024

(54) TERMINAL-EQUIPPED CAPACITOR AND CAPACITOR-INTEGRATED CONNECTOR

(71) Applicants: SUMITOMO WIRING SYSTEMS, LTD., Yokkaichi-shi, Mie (JP); SHIZUKI ELECTRIC CO., INC., Nishinomiya-shi, Hyogo (JP)

(72) Inventors: Takao FUKUDA, Yokkaichi-shi (JP); Kenji ISHII, Nishinomiya-shi (JP)

(73) Assignees: SUMITOMO WIRING SYSTEMS, LTD., Yokkaichi-shi, Mie (JP); SHIZUKI ELECTRIC CO., INC., Nishinomiya-shi, Hyogo (JP)

(21) Appl. No.: 18/562,400

(22) PCT Filed: Jun. 8, 2022
(86) PCT No.: PCT/JP2022/023121

§ 371 Date: Nov. 20, 2023

(30) Foreign Application Priority Data
Jun. 11, 2021 (JP) 2021-098166

(51) Int. Cl. H01G 4/228; H01R 13/66; H01R 24/28

(52) U.S. Cl. CPC H01G 4/228; H01R 13/6625; H01R 24/28

(57) ABSTRACT

A terminal-equipped capacitor includes: a capacitor element that includes a pair of electrodes and a pair of external electrodes connected to the respective electrodes; and a terminal that includes a bonded portion bonded to one of the external electrodes, the bonded portion includes a first partial bonded portion and a second partial bonded portion, a direction of extension of opposite side edges of the first partial bonded portion intersects a direction of extension of opposite side edges of the second partial bonded portion, and the opposite side edges of the first partial bonded portion and the opposite side edges of the second partial bonded portion are bonded to the one of the external electrodes.

### TECHNICAL FIELD

The present disclosure relates to terminal-equipped capacitors and capacitor-integrated connectors.

### BACKGROUND ART

Patent Document 1 discloses that bus bars have protrusions, and the protrusions are soldered to metallikon electrodes of a film capacitor.

### PRIOR ART DOCUMENTS

### Patent Document

Patent Document 1: Japanese Patent Application Laid-Open No. 2014-203943

### SUMMARY

### Problem to be Solved by the Invention

When only the protrusions are soldered to the metallikon electrodes, however, the bonding area of the bus bars to the metallikon electrodes can be small, resulting in an insufficient bonding strength.

It is thus an object of the present disclosure to improve a bonding strength of a terminal to an external electrode of a capacitor element.

### Means to Solve the Problem

A terminal-equipped capacitor according to the present disclosure is a terminal-equipped capacitor including: a capacitor element that includes a pair of electrodes and a pair of external electrodes connected to the respective electrodes; and a terminal that includes a bonded portion bonded to one of the external electrodes, wherein the bonded portion includes a first partial bonded portion and a second partial bonded portion, a direction of extension of opposite side edges of the first partial bonded portion intersects a direction of extension of opposite side edges of the second partial bonded portion, and the opposite side edges of the first partial bonded portion and the opposite side edges of the second partial bonded portion are bonded to the one of the external electrodes.

### Effects of the Invention

According to the present disclosure, a bonding strength of a terminal to an external electrode of a capacitor element can be improved.

### BRIEF DESCRIPTION OF DRAWINGS

FIG. 1 is a plan view illustrating a capacitor-integrated connector.

FIG. 2 is an elevation view illustrating the capacitor-integrated connector.

FIG. 3 is a cross-sectional view taken along the line III-III of FIG. 2.

FIG. 4 is a perspective view illustrating a terminal-equipped capacitor.

FIG. 5 is a schematic cross-sectional view illustrating an internal structure of a capacitor element.

FIG. 6 is a diagram illustrating connection between terminals and capacitor elements.

FIG. 7 is a plan view illustrating another terminal.

FIG. 8 is a diagram illustrating connection between the other terminal and the capacitor elements.

### DESCRIPTION OF EMBODIMENTS

### Description of Embodiments of Present Disclosure

Embodiments of the present disclosure will be listed for description first.

A terminal-equipped capacitor according to the present disclosure is as follows:

(1) A terminal-equipped capacitor including: a capacitor element that includes a pair of electrodes and a pair of external electrodes connected to the respective electrodes; and a terminal that includes a bonded portion bonded to one of the external electrodes, wherein the bonded portion includes a first partial bonded portion and a second partial bonded portion, a direction of extension of opposite side edges of the first partial bonded portion intersects a direction of extension of opposite side edges of the second partial bonded portion, and the opposite side edges of the first partial bonded portion and the opposite side edges of the second partial bonded portion are bonded to the one of the external electrodes.

According to the terminal-equipped capacitor, the bonded portion is bonded to the one of the external electrodes in at least four portions. The bonded portions include portions extending in at least two different directions. This improves a bonding strength of the terminal to the external electrodes of the capacitor element.

(2) The terminal-equipped capacitor according to (1), wherein the direction of extension of the opposite side edges of the first partial bonded portion may be orthogonal to the direction of extension of the opposite side edges of the second partial bonded portion. Force in various directions applied to the terminal can effectively be received in the bonded portions at the opposite side edges of the first partial bonded portion and the bonded portions at the opposite side edges of the second partial bonded portion. This improves the bonding strength of the terminal to the external electrodes of the capacitor element.

(3) The terminal-equipped capacitor according to (1) or (2), wherein the bonded portion may include a third partial bonded portion, a direction of extension of opposite side edges of the third partial bonded portion may intersect the direction of extension of the opposite side edges of the second partial bonded portion, the second partial bonded portion may connect the first partial bonded portion and the third partial bonded portion, and at least one of the side edges of the third partial bonded portion may be bonded to the one of the external electrodes. This further improves the bonding strength of the terminal to the external electrodes of the capacitor element.

(4) The terminal-equipped capacitor according to (3), wherein the first partial bonded portion, the second partial bonded portion, and the third partial bonded portion may each have a shape that extends linearly, and the first partial bonded portion and the third partial bonded portion may extend in orientations parallel to each other, and the second partial bonded portion may connect a distal end of the first partial bonded portion and a distal end of the third partial bonded portion in an orientation perpendicular to each of the first partial bonded portion and the third partial bonded portion.

The strength of the bonded portion as a whole can thus be increased while reducing the width of each of the first partial bonded portion, the second partial bonded portion, and the third partial bonded portion. Reduction in width of each of the first partial bonded portion, the second partial bonded portion, and the third partial bonded portion facilitates heating of the first partial bonded portion, the second partial bonded portion, and the third partial bonded portion and thus facilitates bonding of the bonded portion to the one of the external electrodes.

(5) The terminal-equipped capacitor according to (3) or (4), wherein the third partial bonded portion may be along an edge of the one of the external electrodes, and the first partial bonded portion may be located closer to a center of the one of the external electrodes than the third partial bonded portion is. Disposition of the third partial bonded portion along the edge of the one of the external electrodes facilitates disposition of the first partial bonded portion at the position closer to the center of the one of the external electrodes, so that the bonded portion is stably bonded to the one of the external electrodes.

(6) The terminal-equipped capacitor according to any one of (1) to (5), wherein the terminal may include a terminal body that extends outwardly from the bonded portion and an end of the terminal body on a side of the bonded portion may have a penetrating portion through opposite surfaces of the terminal body. The end of the terminal body on the side of the bonded portion has the penetrating portion through the opposite surfaces of the terminal body, so that heat of the bonded portion is less likely to escape to a side of the terminal body, and the bonded portion is easily bonded to the one of the external electrodes.

A capacitor-integrated connector according to the present disclosure is as follows:

(7) A capacitor-integrated connector including: the terminal-equipped capacitor according to any one of (1) to (6); a housing that contains the capacitor element with an end of the terminal opposite an end bonded to the capacitor element being externally exposed; and a seal that seals the capacitor element within the housing. External wiring can be connected to the capacitor element via the terminal using a portion of the terminal exposed from the housing. The bonding strength of the terminal to the capacitor element is improved, so that removal of the terminal from the capacitor element and the like are suppressed when the terminal-equipped capacitor is incorporated into the housing.

### Details of Embodiment of Present Disclosure

Specific examples of the terminal-equipped capacitor and the capacitor-integrated connector according to the present disclosure will be described below with reference to the drawings. The present disclosure is not limited to these examples, and all changes which are indicated in the claims and come within the meaning and range of equivalency of the claims are intended to be embraced.

### EMBODIMENT

A terminal-equipped capacitor and a capacitor-integrated connector according to an embodiment will be described below.

<Overall Structure of Capacitor-Integrated Connector>

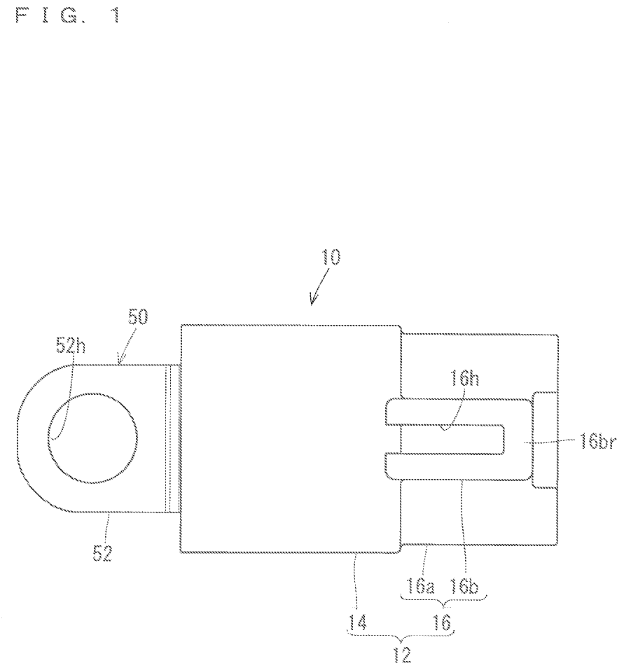

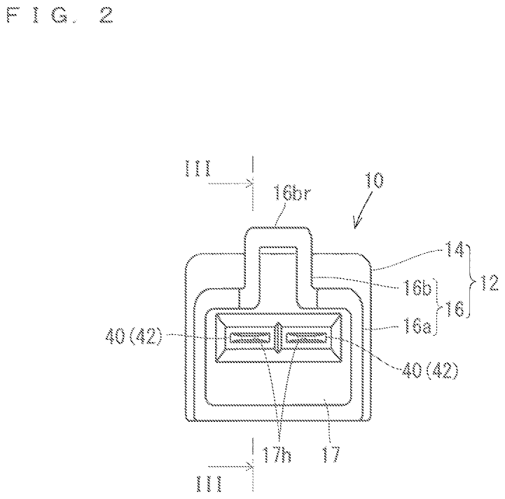

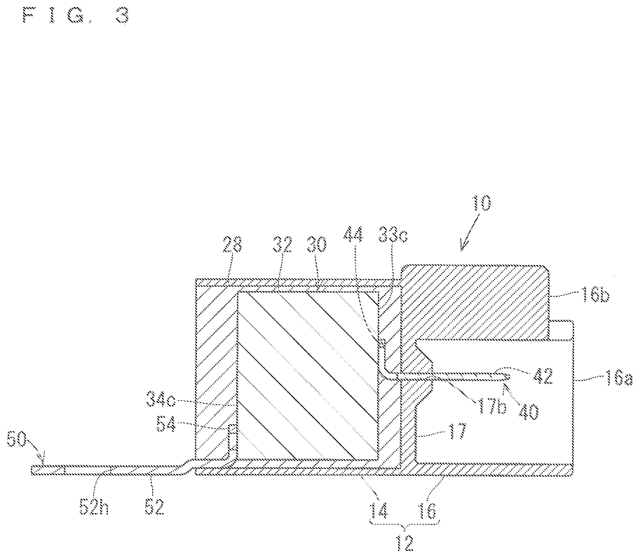

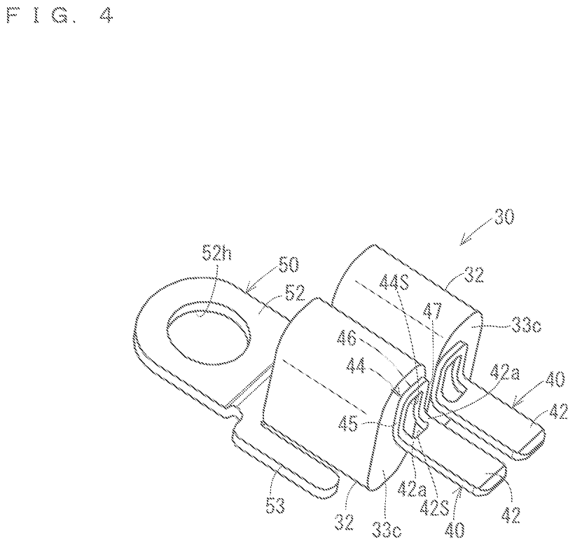

FIG. 1 is a plan view illustrating a capacitor-integrated connector 10. FIG. 2 is an elevation view illustrating the capacitor-integrated connector 10. FIG. 3 is a cross-sectional view taken along the line III-III of FIG. 2. FIG. 4 is a perspective view illustrating a terminal-equipped capacitor 30.

The capacitor-integrated connector 10 includes the terminal-equipped capacitor 30, a housing 12, and a seal 28.

The terminal-equipped capacitor 30 has a configuration in which terminals 40 and a terminal 50 are bonded to capacitor elements 32. The terminals 40 and the terminal 50 may also be referred to as bus bars. In the present embodiment, the terminal-equipped capacitor 30 includes two capacitor elements 32. The terminals 40 are bonded to respective ends of the two capacitor elements 32. The terminal 50, which is common to the two capacitor elements, is bonded to the other ends of the two capacitor elements. The two terminals 40 extend in parallel from the ends of the two capacitor elements 32 arranged in parallel. The one terminal 50 extends from the other ends of the two capacitor elements 32 in a direction opposite a direction of extension of the two terminals 40.

The terminal-equipped capacitor 30 may include one capacitor element 32. In this case, the terminal-equipped capacitor 30 includes one terminal 40 bonded to the one capacitor element 32. The terminal 50 is bonded only to the one capacitor element 32.

The housing 12 is a member for containing the capacitor elements 32. The housing 12 is formed of an insulating material, such as a resin. The housing 12 is a member integrally molded using a resin, for example. The housing 12 includes an element container 14 and a connecter housing 16.

The element container 14 is in the form of a rectangular box having an opening. The capacitor elements 32, herein, the two capacitor elements 32 arranged in parallel are contained in a space in the element container 14. The space in the element container 14 is formed to have a size that allows the capacitor elements 32 to be contained without extending beyond the space.

The connecter housing 16 is in the form of a tube opening in one direction. In the present embodiment, the connecter housing 16 has a configuration in which a protrusion forming portion 16b protruding outward merges into the center of a portion corresponding to a long side of a body portion 16a in the form of a rectangular tube to form one tube. The $ protrusion forming portion 16b is formed to protrude along a longitudinal direction of the connecter housing 16. An outward-facing surface of the protrusion forming portion 16b has a slit 16h extending along a longitudinal direction of the protrusion forming portion, except for a portion on a side of the opening of the connecter housing 16. A receiving piece 16br extending along a width direction of the connecter housing 16 is provided to a portion present on a side of the opening of the connecter housing 16 relative to the slit 16h.

An unillustrated mating connector connected to the connecter housing 16 is inserted into the connecter housing 16. In this state, a locking portion of the mating connector is inserted into the slit 16h and can be locked to the receiving piece 16br for retention.

A partition 17 is formed between the element container 14 and the connecter housing 16. The partition 17 is a portion forming the bottom of the internal space of the element container 14 and also forming the bottom of the connecter housing 16. The partition 17 has terminal insertion holes 17h through which the terminals 40 are inserted. Two terminal insertion holes 17h are herein formed to correspond to the two terminals 40. The terminal insertion holes 17h preferably have sizes that allow for press fitting of the terminals 40.

With the capacitor elements 32 being contained in the element container 14, the terminals 40 are inserted through the terminal insertion holes 17h. Leading ends of the terminals 40 opposite ends connected to the capacitor elements 32 are externally exposed within the connecter housing 16. When the mating connector is inserted into the connecter housing 16, the terminals 40 are inserted into and connected to mating terminals in the mating connector.

A leading end of the terminal 50 opposite an end bonded to the capacitor elements 32 protrudes outwardly from an opening of the element container 14. The leading end of the terminal 50 is fixed to a fixing target portion. For example, the leading end of the terminal 50 has a hole 52h. A screw is inserted through the hole 52h and is threaded into a screw hole of the fixing target portion to fix the leading end of the terminal 50 to the fixing target portion. The fixing target portion is a grounding target portion, such as a metal body of a vehicle, for example.

The seal 28 seals the capacitor elements 32 within the above-mentioned element container 14. The seal 28 is formed by filling a resin in a fluid state into the element container 14 and then curing the resin with the capacitor elements 32 being contained in the element container 14, for example. While an epoxy resin is often commonly used as the filled resin, the filled resin may be a resin melting from heat and may be a moisture-curable liquid resin or a photo-curable liquid resin.

The capacitor-integrated connector 10 is incorporated into the vehicle while being interposed between a power supply circuit and a ground circuit as a component for protection against a noise made by a defogger, a high mounted stop lamp, and the like, for example. The capacitor-integrated connector 10 may be incorporated into electrical equipment, industrial equipment, and the like other than the vehicle. For example, the terminal 50 is fixed while being grounded to the grounding target portion, and the mating connector of a power supply is connected to the connecter housing 16.

<Terminal-Equipped Capacitor>

The terminal-equipped capacitor 30 will be described more specifically. As described above, the terminal-equipped capacitor 30 includes the capacitor elements 32, the terminals 40, and the terminal 50.

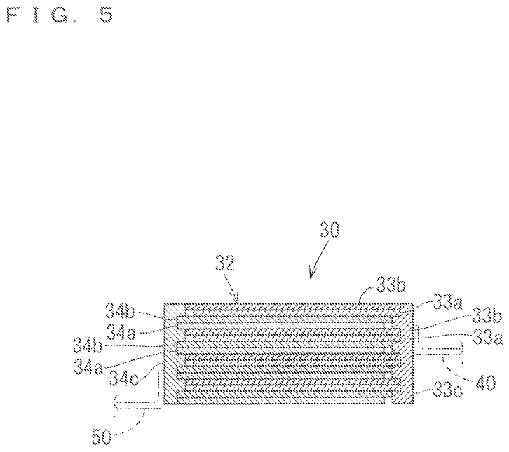

FIG. 5 is a schematic cross-sectional view illustrating an internal structure of each of the capacitor elements 32. The thickness of each component is exaggerated in FIG. 5. The capacitor element 32 includes a pair of electrodes 33a and 34a and external electrodes 33c and 34c connected to the respective electrodes 33a and 34a. A dielectric is disposed between the electrodes 33a and 34a. For example, the electrode 33a is formed by depositing aluminum and the like on a side of one surface of a film 33b as the dielectric. The electrode 34a is formed by depositing aluminum and the like on a side of one surface of a film 34b as the dielectric. With the electrode 33a, the film 33b, the electrode 34a, and the film 34b being stacked in this order, the stack is wound. The electrodes 33a and 34a are thereby rounded while being separated by the films 33b and 34b, and charge can be stored between the electrodes 33a and 34a.

The film 33b on which the electrode 33a has been formed and the film 34b on which the electrode 34a has been formed described above are wound while being offset in a direction along a winding axis. As a result, the electrode 33a and the film 33b extend beyond the electrode 34a and the film 34b to be exposed on one side in an axial direction of the winding, and the electrode 34a and the film 34b extend beyond the electrode 33a and the film 33b to be exposed on the other side in the axial direction of the winding.

The external electrode 33c is formed on one side in the axial direction of the winding. The external electrode 33c is an electrode exposed to one end surface in the axial direction of the winding while being connected to the electrode 33a. The external electrode 34c is formed on the other side in the axial direction of the winding. The external electrode 34c is an electrode exposed to the other end surface in the axial direction of the winding while being connected to the electrode 34a.

The above-mentioned external electrodes 33e and 34c are formed by melting a thermal spray material, such as a zinc-tin alloy, tin, and aluminum, and spraying the melted thermal spray material to one side or the other side in the axial direction of the winding, for example. The sprayed thermal spray material is bonded to the electrode 33a on one side in the axial direction of the winding to be the external electrode 33c. The sprayed thermal spray material is bonded to the electrode 34a on the other side in the axial direction of the winding to be the external electrode 34c. The external electrodes 33c and 34c are exposed on a side of one end or a side of the other end in the axial direction of the capacitor element 32. For example, the external electrodes 33c and 34c have outward-facing surfaces orthogonal to the axial direction of the winding. The external electrodes 33c and 34c having such a configuration may be electrodes referred to as metallikon electrodes.

The terminals 40 are connected to respective external electrodes 33c of the two capacitor elements 32. The terminal 50, which is common to the two capacitor elements 32, is connected to external electrodes 34c of the two capacitor elements 32. The terminal-equipped capacitor 30 is not necessarily required to include both the terminals 40 and the terminal 50. For example, electric wiring may be used in place of the terminals 40 or the terminal 50, and the electric wiring may be connected to the external electrodes 33c or the external electrodes 34c of the capacitor elements 32.

<Terminals and Their Bonding Configuration>

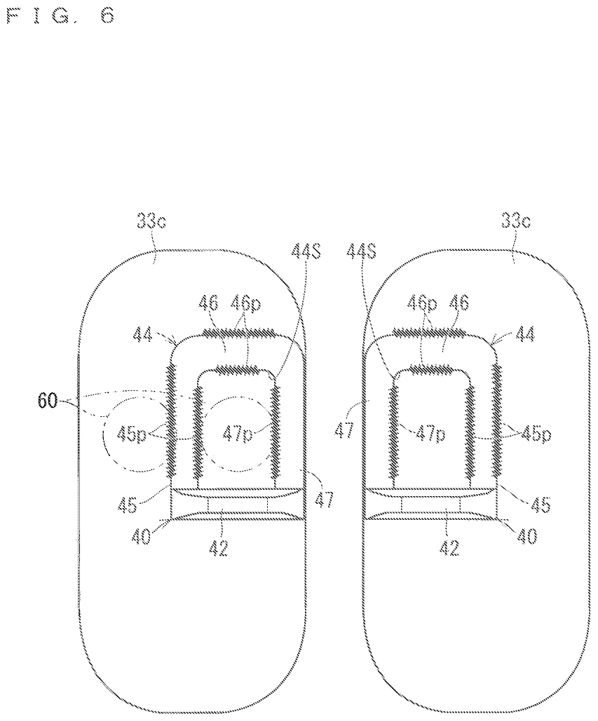

The terminals 40 and their bonding configuration will be described. FIG. 6 is a diagram illustrating connection between the terminals 40 and the capacitor elements 32.

As shown in FIGS. 3 to 6, the terminals 40 are each bonded to the external electrode 33c as one of the pair of external electrodes 33c and 34c. The terminals 40 are each formed by pressing a plate formed of copper, a copper alloy, and the like, for example. A plating layer formed of tin, nickel, and the like may be formed on the surface of each of the terminals 40.

Each of the terminals 40 includes a terminal body 42 and a bonded portion 44. The terminal body 42 is a portion used for connection to a connection target. In the present embodiment, the terminal body 42 is in the form of a linear plate and is inserted into and connected to a mating terminal. The bonded portion 44 is a portion bonded to the external electrode 33c. In the present embodiment, the bonded portion 44 is continuous with the terminal body 42 while being bent. The bonded portion 44 and the terminal body 42 are herein continuous to form an angle of 90°. The bonded portion 44 and the terminal body 42 may be continuous to form an angle different from 90° and may be continuous linearly.

The bonded portion 44 includes a first partial bonded portion 45 and a second partial bonded portion 46. A direction of extension of opposite side edges of the first partial bonded portion 45 intersects a direction of extension of opposite side edges of the second partial bonded portion 46. The opposite side edges of the first partial bonded portion 45 and the opposite side edges of the second partial bonded portion 46 are bonded to the external electrode 33c.

More specifically, the first partial bonded portion 45 is in the form of an elongated plate extending from one end of an edge on a side of a base end of the terminal body 42. The first partial bonded portion 45 is herein bent perpendicularly to the terminal body 42 and extends to a side of one main surface of the terminal body 42.

The second partial bonded portion 46 extends from a distal end of the first partial bonded portion 45 in a direction intersecting the first partial bonded portion 45. The second partial bonded portion 46 is herein bent from the distal end of the first partial bonded portion 45 and extends perpendicularly to the first partial bonded portion 45. The second partial bonded portion 46 may face the center in a width direction of the terminal body 42 as illustrated in FIG. 4 and the like. The second partial bonded portion 46 may face outward in the width direction of the terminal body 42. A direction of extension of the second partial bonded portion 46 is parallel to a direction of extension of the edge on the side of the base end of the terminal body 42. The second partial bonded portion 46 has a length approximately equal to a width dimension of the terminal body 42.

The first partial bonded portion 45 is in the form of a linear plate having a fixed width, and the second partial bonded portion 46 is also in the form of a linear plate having a fixed width. Thus, the opposite side edges of the first partial bonded portion 45 extend in parallel, and the opposite side edges of the second partial bonded portion 46 extend in parallel. The direction of extension of the opposite side edges of the first partial bonded portion 45 intersects (is herein orthogonal to) the direction of extension of the opposite side edges of the second partial bonded portion 46. That is to say, the first partial bonded portion 45 and the second partial bonded portion 46 are continuous to form an L-shape.

Each of the terminals 40 includes a third partial bonded portion 47. A direction of extension of opposite side edges of the third partial bonded portion 47 intersects the direction of extension of the opposite side edges of the second partial bonded portion 46. The second partial bonded portion 46 connects the first partial bonded portion 45 and the third partial bonded portion 47.

In the present embodiment, the third partial bonded portion 47 is in the form of an elongated plate extending from the other end of the edge on the side of the base end of the terminal body 42. The first partial bonded portion 45 and the third partial bonded portion 47 are provided to the edge on the side of the base end of the terminal body 42 to be spaced from each other. The third partial bonded portion 47 is in the form of an elongated plate. The third partial bonded portion 47 is herein bent perpendicularly to the terminal body 42 and extends to the side of one main surface of the terminal body 42. The first partial bonded portion 45 and the third partial bonded portion 47 thus extend to be spaced from each other in orientations parallel to each other.

The third partial bonded portion 47 is in the form of a linear plate having a fixed width. The opposite side edges of the third partial bonded portion 47 thus extend in parallel. The direction of extension of the opposite side edges of the third partial bonded portion 47 intersects (is herein orthogonal to) the direction of extension of the opposite side edges of the second partial bonded portion 46.

The second partial bonded portion 46 connects the distal end of the first partial bonded portion 45 and a distal end of the third partial bonded portion 47. The second partial bonded portion 46 is in an orientation perpendicular to each of the first partial bonded portion 45 and the third partial bonded portion 47. The first partial bonded portion 45, the second partial bonded portion 46, and the third partial bonded portion 47 are thus connected perpendicularly to form a U-shape.

The first partial bonded portion 45, the second partial bonded portion 46, and the third partial bonded portion 47 may be formed to have the same width and may be formed to have different widths. For example, the first partial bonded portion 45, the second partial bonded portion 46, and the third partial bonded portion 47 may be formed to have the same width of 1 mm. Alternatively, the first partial bonded portion 45 may be formed to have a width of 1.5 mm, and the second partial bonded portion 46 may be formed to have a width of 0.9 mm, for example. The third partial bonded portion 47 may be omitted.

An opening, herein, a square opening 44S is formed among the first partial bonded portion 45, the second partial bonded portion 46, and the third partial bonded portion 47.

An end of the terminal body 42 on a side of the bonded portion 44, that is, a portion of the terminal body 42 closer to the bonded portion 44 than the center in a longitudinal direction of the terminal body 42 is has a penetrating portion 428 through opposite surfaces of the terminal body 42. The above-mentioned opening 44S is contiguous with the penetrating portion 42S of the terminal body 42. More specifically, the first partial bonded portion 45 and the third partial bonded portion 47 are connected to the opposite ends of the edge on the side of the base end of the terminal body 42, and the opening 44S is formed between them. The opening 44S extends toward the base end of the terminal body 42 to form the penetrating portion 428. Portions of the terminal body 42 on opposite sides of the penetrating portion 42S are a pair of narrow connection portions 42a. The narrow connection portions 42a each have the same width as the first partial bonded portion 45 or the third partial bonded portion 47 and are each narrower than the terminal body 42. The penetrating portion 42S is not required to be a space contiguous with the opening 44S and may be formed as a through hole different from the opening 44S.

The first partial bonded portion 45, the second partial bonded portion 46, and the third partial bonded portion 47 are each not necessarily required to be in the form of a linear plate. Not the square opening 44S but an opening having another shape, for example, a circular opening may thus be formed among the first partial bonded portion 45, the second partial bonded portion 46, and the third partial bonded portion 47. All the edges of the first partial bonded portion 45, the second partial bonded portion 46, and the third partial bonded portion 47 are thus not necessarily required to be linear, and some or all of the edges may be curved. In a case where any of the edges of the first partial bonded portion 45, the second partial bonded portion 46, and the third partial bonded portion 47 is curved, whether the curved edge intersects another edge is required to be determined based on any of tangents of the curved edge. For example, when any of the tangents of the curved edge intersects another linear edge, it can be said that these edges intersect each other.

The bonded portion 44 is bonded to an outward-facing surface of the external electrode 33c as illustrated in FIG. 6. That is to say, the opposite side edges of the first partial bonded portion 45 are bonded by welded portions 45p. The opposite side edges of the second partial bonded portion 46 are bonded by welded portions 46p. At least one of the edges of the third partial bonded portion 47 is preferably bonded by a welded portion 47p. The positions of the welded portions 45p, 46p, and 47p in FIG. 6 are examples. For example, the welded portions 45p are sometimes formed in regions larger or smaller than the side edges of the first partial bonded portion 45. The welded portions 45p at the side edges of the first partial bonded portion 45 and the welded portions 46p at the side edges of the second partial bonded portion 46 can integrally be connected.

The welded portions 45p, 46p, and 47p are portions that are obtained by at least the external electrode 33c or the bonded portion 44 solidifying after melting to be a state to bond the bonded portion 44 to the external electrode 33c. Bonding the bonded portion 44 to the external electrode 33c means fixing them to mechanically maintain a certain positional relationship with the bonded portion 44 and the external electrode 330 being electrically connected.

The bonded portion 44 and the external electrode 33e are bonded together as described below, for example. That is to say, a surface of the bonded portion 44 opposite the terminal body 42 is brought into contact with the outward-facing surface of the external electrode 33c.

In a case where spacing between an outer edge of the first partial bonded portion 45 and an outer edge of the third partial bonded portion 47 exceeds the width of the external electrode 33c, the outer edge of the third partial bonded portion 47 may be disposed along an edge of the external electrode 33c. The first partial bonded portion 45 is thus easily disposed closer to the center of the external electrode 33c than the third partial bonded portion 47 is based on the third partial bonded portion 47 disposed to be aligned with the edge of the external electrode 33c. The outer edge of the third partial bonded portion 47 and the edge of the external electrode 33c can easily be aligned by visual confirmation. By bringing the outer edge of the third partial bonded portion 47 and the edge of the external electrode 33c into contact with a positioning jig, the edges of them can easily be aligned.

With the bonded portion 44 being brought into contact with the external electrode 33c, a pair of chip electrodes 60 for resistance welding is brought into contact with the bonded portion 44. The pair of chip electrodes 60 is indicated by alternate long and two short dashes lines in FIG. 6. The chip electrodes 60 are electrodes to apply a voltage for resistance welding to a welding target. End surfaces of the chip electrodes 60 are each formed to have a diameter of 3 mm, for example, and spacing between the chip electrodes 60 is set to 0.5 mm, for example.

The pair of chip electrodes 60 is pressed against any portions of the first partial bonded portion 45 and the second partial bonded portion 46. In this case, if the width of the first partial bonded portion 45 and the width of the second partial bonded portion 46 are each greater than the spacing between the chip electrodes 60, the pair of chip electrodes 60 is easily simultaneously pressed against the first partial bonded portion 45 or the second partial bonded portion 46. If spacing between the first partial bonded portion 45 and the third partial bonded portion 47 is smaller than the diameter of each of the chip electrodes 60, the chip electrodes 60 are easily in contact with any of the partial bonded portions 45, 46, and 47 without being fit into the opening 44S, so that the pair of chip electrodes 60 easily surely applies a voltage.

When the pair of chip electrodes 60 is pressed against any portions of the first partial bonded portion 45 and the second partial bonded portion 46, portions where the bonded portion 44 and the chip electrodes 60 are in contact with each other produce heat due to Joule heat by contact resistance. Due to the heat, the external electrode 33c melts, and the opposite side edges of the first partial bonded portion 45 and the opposite side edges of the second partial bonded portion 46 are welded to the external electrode 33c by resistance welding. Any one of the edges of the third partial bonded portion 47, in particular, an edge on a side of the first partial bonded portion 45 may be welded to the external electrode 33c similarly to the foregoing. An edge of the third partial bonded portion 47 opposite the first partial bonded portion 45 may be bonded to the external electrode 33c.

Heat is transferred to the terminal body 42 when the bonded portion 44 is welded. The base end of the terminal body 42, however, has the penetrating portion 42S. Heat is thus less likely to be transferred from the bonded portion 44 to a leading end of the terminal body 42. Heat produced at the bonded portion 44 is thus less likely to escape to a side of the terminal body 42 to enable efficient welding of the bonded portion 44.

The terminals 40 are welded to the respective two capacitor elements 32 as described above.

The external electrodes 33c and the bonded portions 44 may be bonded together by soldering.

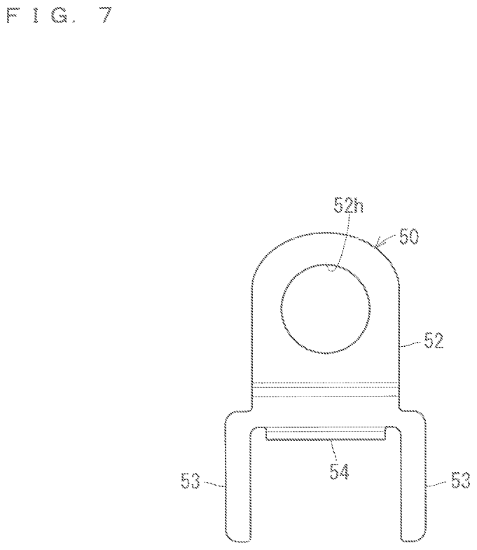

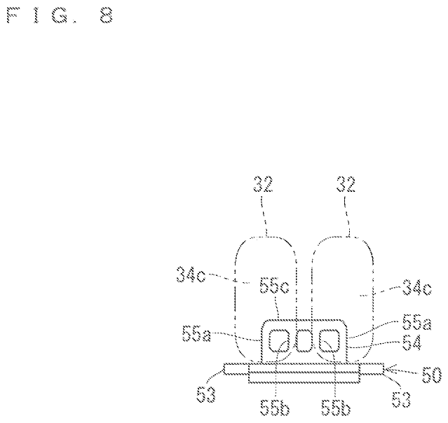

The terminal 50 is bonded to the external electrodes 34c. FIG. 7 is a plan view illustrating the terminal 50, and FIG. 8 is a diagram illustrating connection between the terminal 50 and the capacitor elements 32. The capacitor elements 32 are indicated by alternate long and two short dashes lines in FIG. 8.

The terminal 50 is formed by pressing a plate formed of copper, a copper alloy, and the like, for example. A plating layer formed of tin, nickel, and the like may be formed on the surface of the terminal 50.

The terminal 50 includes a terminal body 52 and a bonded portion 54. The terminal body 52 is a portion used for connection to a connection target. In the present embodiment, the terminal body 52 is in the form of a linear plate and has a hole 52h in a leading end thereof. A screw is inserted through the hole 52h and is threaded at a fixing target portion to fix and electrically connect the terminal body 52 to the fixing target portion. The bonded portion 54 is a portion bonded to the external electrodes 34c. In the present embodiment, the bonded portion 54 and the terminal body 52 are continuous to form an angle of 90°. The bonded portion 54 and the terminal body $2 may be continuous to form an angle different from 90° and may be continuous linearly. In the present embodiment, a pair of extension pieces 53 is formed at positions in a base end of the terminal body $2 and outside the bonded portion 54. The pair of extension pieces 53 is located outside the two capacitor elements 32 at positions below bottom surfaces of the two capacitor elements 32. The pair of extension pieces 53 is in contact with an inner surface of the element container 14 within the element container 14 and can perform a function to maintain the position of the terminal-equipped capacitor 30 constant. The extension pieces 53 may be omitted.

The bonded portion $4 includes a pair of side pieces 55a and a pair of intermediate pieces 55b between the side pieces 55a. Distal ends of the pair of side pieces 55a and distal ends of the pair of intermediate pieces 55b are connected by a connection piece 55c. Openings are formed between one of the side pieces 55a and one of the intermediate pieces 55b, between the intermediate pieces 55b, and between the other one of the side pieces 55a and the other one of the intermediate pieces 55b.

The bonded portion 54 is bonded to an external electrode 34c of one of the capacitor elements 32 with one of the side pieces 55a as a portion corresponding to the above-mentioned first partial bonded portion 45 and a portion of the connection piece 55c between one of the side pieces 55a and one of the intermediate pieces 55b as a portion corresponding to the above-mentioned second partial bonded portion 46. In this case, one of the intermediate pieces 55b may be bonded to the external electrode 34c as a portion similar to the above-mentioned third partial bonded portion 47.

The bonded portion 54 is bonded to an external electrode 34c of the other one of the capacitor elements 32 with the other one of the side pieces 55a as a portion corresponding to the above-mentioned first partial bonded portion 45 and a portion of the connection piece 55c between the other one of the side pieces 55a and the other one of the intermediate pieces 55b as a portion corresponding to the above-mentioned second partial bonded portion 46. Also in this case, the other one of the intermediate pieces 55b may be bonded to the external electrode 34c as a portion similar to the above-mentioned third partial bonded portion 47.

The external electrodes 34c of the two capacitor elements 32 are thereby bonded to the bonded portion 54, and the two capacitor elements 32 are maintained in parallel.

<Effects and Others>

According to the terminal-equipped capacitor 30 and the capacitor-integrated connector 10 having such configurations, the bonded portion 44 is bonded to the external electrode 33c in at least four portions, that is, at the opposite side edges of the first partial bonded portion 45 and the opposite side edges of the second partial bonded portion 46. This increases the bonding area. The bonded portions extend in at least two different directions. The welded portions 45p along the opposite side edges of the first partial bonded portion 45 and the welded portions 46p along the opposite side edges of the second partial bonded portion 46 can thus reinforce each other. For example, assuming that only the opposite side edges of the first partial bonded portion 45 are bonded to the external electrode 33c, the welded portions 45p can easily be broken when the first partial bonded portion 45 is tilted relative to an axial direction of the first partial bonded portion 45. When the opposite side edges of the second partial bonded portion 46 are also bonded to the external electrode 33c, however, force to tilt the first partial bonded portion 45 about an axis thereof can be received by the welded portions 46p. As described above, force to separate the first partial bonded portion 45 from the external electrode 33c is effectively received by the welded portions 45p and 46p extending in a plurality of directions. This improves a bonding strength of the terminal 40 to the external electrode 33c of the capacitor element 32 and improve reliability of connection between them.

When the direction of extension of the opposite side edges of the first partial bonded portion 45 is orthogonal to the direction of extension of the opposite side edges of the second partial bonded portion 46, force in various directions applied to the terminal 40 can effectively be received in the welded portions 45p as the bonded portions at the opposite side edges of the first partial bonded portion 45 and the welded portions 46p as the bonded portions at the opposite side edges of the second partial bonded portion 46. This further improves the bonding strength of the terminal 40 to the external electrode 33c of the capacitor element 32.

At least one of the side edges of the third partial bonded portion 47 is bonded to the external electrode 33c to further improve the bonding strength of the terminal 40 to the external electrode 33c of the capacitor element 32.

The first partial bonded portion 45, the second partial bonded portion 46, and the third partial bonded portion 47 are each in the form of a linear plate and are continuous to form a U-shape as a whole while being orthogonal to each other. The strength of the bonded portion 44 as a whole can thus be increased while reducing the width of each of the first partial bonded portion 45, the second partial bonded portion 46, and the third partial bonded portion 47. As a result, the terminal 40 is securely fixed to the capacitor element 32. Reduction in width of each of the first partial bonded portion 45, the second partial bonded portion 46, and the third partial bonded portion 47 facilitates heating of them and thus facilitates bonding of the bonded portion 44 to the external electrode 33c. The bonded portion 44 is less likely to be deformed even in a case where the terminal 40 is subjected to processing such as plating.

The second partial bonded portion 46 intersects the first partial bonded portion 45. Assuming herein that the bonded portion 44 includes only the first partial bonded portion 45, a precision work to accurately dispose the first partial bonded portion 45 between the chip electrodes 60 is required to bring both the chip electrodes 60 into contact with the first partial bonded portion 45. When the second partial bonded portion 46 intersects the first partial bonded portion 45, at least one of the chip electrodes 60 is easily brought into contact with the second partial bonded portion 46 even if both the chip electrodes 60 cannot be brought into contact with the first partial bonded portion 45. The pair of chip electrodes 60 can thus be brought into contact with any portions of the first partial bonded portion 45 and the second partial bonded portion 46 to easily perform resistance welding.

Addition of the third partial bonded portion 47 allows for contact of the pair of chip electrodes 60 with any portions of the first partial bonded portion 45, the second partial bonded portion 46, and the third partial bonded portion 47 for resistance welding to more easily perform resistance welding.

The third partial bonded portion 47 is along the edge of the external electrode 33c, and the first partial bonded portion 45 is located closer to the center of the external electrode 33c than the third partial bonded portion 47 is. The first partial bonded portion 45 is thus easily bonded at a position closer to the center of the external electrode 33c based on the position of the third partial bonded portion 47 relative to the edge of the external electrode 33c, and the bonded portion 44 is stably bonded to the external electrode 33c.

As for a bonded portion of the terminal 50 to the external electrodes 34c, an effect of improving the bonding strength and the like can be obtained similarly to the foregoing.

The end of the terminal body 42 of the terminal 40 on a side of the bonded portion 44 has the penetrating portion 42S, so that heat of the bonded portion 44 is less likely to escape to the side of the terminal body 42, and the bonded portion 44 is easily bonded to the external electrode 33c.

According to the capacitor-integrated connector 10, external wiring can be connected to the capacitor elements 32 using a portion of the terminal 40 exposed from the housing 12 (the terminal body 42). A bonding strength of the terminal body 42 to the capacitor element is improved, so that removal of the terminal 40 from the capacitor element 32 and the like are suppressed when the terminal-equipped capacitor 30 is Incorporated into the housing 12. For example, even if excess force is applied to a base of the terminal 40 when the terminal 40 is inserted through the terminal insertion hole 17h, in particular, when the terminal 40 is press fit into the terminal insertion hole 17h, the terminal 40 is less likely to be removed from the capacitor element 32.

Configurations described in the above-mentioned embodiments and modifications can be combined with each other as appropriate unless any contradiction occurs.

### EXPLANATION OF REFERENCE SIGNS

10 capacitor-integrated connector
12 housing
14 element container
16 connecter housing
16a body portion
16b protrusion forming part
16h slit
16br receiving piece
17 partition
17h terminal insertion hole
28 seal
30 terminal-equipped capacitor
32 capacitor element
33a, 34a electrode
33b, 34b film
33c, 34c external electrode
40, 50 terminal
42, 52 terminal body
42S penetrating portion
42a narrow connection portion
44, 54 bonded portion
44S opening
45 first partial bonded portion
45p, 46p, 47p welded portion
46 second partial bonded portion
47 third partial bonded portion
52h hole
53 extension piece
55a side piece
55b intermediate piece
55c connection piece
60 chip electrode

1-7. (canceled)

8. A terminal-equipped capacitor comprising:
a capacitor element that includes a pair of electrodes and a pair of external electrodes connected to the respective electrodes; and
a terminal that includes a bonded portion bonded to one of the external electrodes and a terminal body in the form of a linear plate, the terminal having been formed by pressing a plate so that the terminal body is continuous with the bonded portion, wherein
the bonded portion includes a first partial bonded portion and a second partial bonded portion,
a direction of extension of opposite side edges of the first partial bonded portion intersects a direction of extension of opposite side edges of the second partial bonded portion, and
the opposite side edges of the first partial bonded portion and the opposite side edges of the second partial bonded portion are bonded to the one of the external electrodes.

9. A terminal-equipped capacitor comprising:
a capacitor element that includes a pair of electrodes and a pair of external electrodes connected to the respective electrodes; and
a terminal that includes a bonded portion bonded to one of the external electrodes, wherein
the bonded portion includes a first partial bonded portion and a second partial bonded portion,
a direction of extension of opposite side edges of the first partial bonded portion intersects a direction of extension of opposite side edges of the second partial bonded portion,
the opposite side edges of the first partial bonded portion and the opposite side edges of the second partial bonded portion are bonded to the one of the external electrodes, and
the direction of extension of the opposite side edges of the first partial bonded portion is orthogonal to the direction of extension of the opposite side edges of the second partial bonded portion.

10. The terminal-equipped capacitor according to claim 8, wherein
the bonded portion includes a third partial bonded portion,
a direction of extension of opposite side edges of the third partial bonded portion intersects the direction of extension of the opposite side edges of the second partial bonded portion,
the second partial bonded portion connects the first partial bonded portion and the third partial bonded portion, and
at least one of the side edges of the third partial bonded portion is bonded to the one of the external electrodes.

11. The terminal-equipped capacitor according to claim 9, wherein
the bonded portion includes a third partial bonded portion,
a direction of extension of opposite side edges of the third partial bonded portion intersects the direction of extension of the opposite side edges of the second partial bonded portion,
the second partial bonded portion connects the first partial bonded portion and the third partial bonded portion, and
at least one of the side edges of the third partial bonded portion is bonded to the one of the external electrodes.

12. A terminal-equipped capacitor comprising:
a capacitor element that includes a pair of electrodes and a pair of external electrodes connected to the respective electrodes; and
a terminal that includes a bonded portion bonded to one of the external electrodes, wherein
the bonded portion includes a first partial bonded portion and a second partial bonded portion,
a direction of extension of opposite side edges of the first partial bonded portion intersects a direction of extension of opposite side edges of the second partial bonded portion,
the opposite side edges of the first partial bonded portion and the opposite side edges of the second partial bonded portion are bonded to the one of the external electrodes,
the bonded portion includes a third partial bonded portion,
a direction of extension of opposite side edges of the third partial bonded portion intersects the direction of extension of the opposite side edges of the second partial bonded portion,
the second partial bonded portion connects the first partial bonded portion and the third partial bonded portion,
at least one of the side edges of the third partial bonded portion is bonded to the one of the external electrodes,
the first partial bonded portion, the second partial bonded portion, and the third partial bonded portion each have a shape that extends linearly, and
the first partial bonded portion and the third partial bonded portion extend in orientations parallel to each other, and the second partial bonded portion connects a distal end of the first partial bonded portion and a distal end of the third partial bonded portion in an orientation perpendicular to each of the first partial bonded portion and the third partial bonded portion.

13. The terminal-equipped capacitor according to claim 12, wherein
the third partial bonded portion is along an edge of the one of the external electrodes, and the first partial bonded portion is located closer to a center of the one of the external electrodes than the third partial bonded portion is.

14. The terminal-equipped capacitor according to claim 9, wherein
the terminal includes a terminal body that extends outwardly from the bonded portion, and
an end of the terminal body on a side of the bonded portion has a penetrating portion through opposite surfaces of the terminal body.

15. A capacitor-integrated connector comprising:
the terminal-equipped capacitor according to claim 8;
a housing that contains the capacitor element with an end of the terminal opposite an end bonded to the capacitor element being externally exposed; and
a seal that seals the capacitor element within the housing.

16. A capacitor-integrated connector comprising:
the terminal-equipped capacitor according to claim 9;
a housing that contains the capacitor element with an end of the terminal opposite an end bonded to the capacitor element being externally exposed; and
a seal that seals the capacitor element within the housing.

17. A capacitor-integrated connector comprising:
the terminal-equipped capacitor according to claim 12;
a housing that contains the capacitor element with an end of the terminal opposite an end bonded to the capacitor element being externally exposed; and
a seal that seals the capacitor element within the housing.
